(19) United States
(12) Patent Application Publication
(10) Pub. No.: US 2019/0337211 A1
(43) Pub. Date: Nov. 7, 2019

(54) DISTRIBUTIVE AND DISPERSIVE MIXING DEVICES

(71) Applicant: University of Massachusetts, Boston, MA (US)

(72) Inventor: David O. Kazmer, Georgetown, MA (US)

(21) Appl. No.: 16/400,102

(22) Filed: May 1, 2019

Related U.S. Application Data
(60) Provisional application No. 62/666,407, filed on May 3, 2018.

(51) Int. Cl. B29C 48/00; B29C 48/693; B29C 48/06; B01F 5/06; B29C 48/22

(52) U.S. Cl. CPC B29C 48/001; B29C 48/693; B29C 48/22; B01F 5/061; B29C 48/06

(57) ABSTRACT

Mixers are disclosed for the processing of one or more materials to be used, for example, in conjunction with injection molding breaker plates. The disclosed embodiments include the use of multiple integral flow channels having non-linear flow paths that vary in their radial, angular, and axial directions. The cross-section of the flow channels can also vary the nature of distributive and dispersive mixing. A method for the design of the mixers is also disclosed. The use of multiple stages of mixing is also disclosed.

### RELATED APPLICATIONS

This application is related to and claims the benefit of earlier filed U.S. Provisional Patent Application Ser. No. 62/666,407 entitled “DISTRIBUTIVE AND DISPERSIVE MIXING DEVICES,” Attorney Docket No. UML18-06(2018-021-01) p, filed on May 3, 2018, the entire teachings of which are incorporated herein by this reference.

### FIELD OF THE INVENTION

The invention relates generally to a device and method for mixing a plastic melt flow.

### BACKGROUND

Breaker plates are widely used in extrusion as an interface between one or more barrels containing corresponding plasticating screws and one or more forming dies. The materials being supplied to the die or other molding or forming systems often includes non-uniformities such as agglomerated fillers, gels of varying composition, and local color variations as well as fluctuations in pressure, temperature, and flow rate. Traditional breaker plates and flow conduits, even with screens or meshes at their inlets, do not provide sufficient distributive and dispersive mixing, and so inconsistencies in the processing states and processed materials can result in reduced processing performance and defective products.

Prior art breaker plates used in thermoplastic extrusion are typically comprised of a flat disc having a number of straight holes of equal diameter and constant section. The consequence of this configuration is that the material flowing through the holes is processed in essentially the same manner, with little distributive or dispersive mixing. These standard mixing plates are widely used with minor variations related to hole size, number of holes, and disc thickness or shape. It is noted that breaker plates can comprise other shapes, such as a disc with a downstream conical section, in order to interface the flow with the die.

Also known in the art is the use of static (also referred to motionless) mixers to homogenize the flow such as disclosed by U.S. Pat. No. 5,971,603. Such mixers may be formed by alternately and longitudinally coupling horizontal and vertical mixing elements, which are so arranged that the facing end edges of the cutting blades of each two adjacent mixing elements cross. While these mixing elements can provide for more homogeneous flow, they are relatively large and can cause issues related to degradation and reliability. U.S. Pat. No. 5,971,603 describes a prior art breaker plate that incorporates a static mixing elements inside a breaker plate using multiple crossing tear-drop shaped members. U.S. Pat. No. 5,346,383 describes a low shear, free-flow extruder breaker plate that provides a plurality of symmetrically arranged tapered holes having a greater diameter at their upstream ends (facing the extruder screw) than at their downstream ends (facing the crosshead).

### SUMMARY

Described herein are apparatuses and techniques for increasing the homogeneity of the melt during extrusion processes using distributive and dispersive mixers in breaker plates. Distributive and dispersive mixing elements can be incorporated into breaker plates and other mixers to increase extrudate quality without significant increases in machinery or processing cost. While embodiments disclosed herein are applicable to many manufacturing and chemical production processes, thermoplastic extrusion will serve as an exemplary field. One skilled in the art would understand that the examples provided herein as breaker plates for extrusion can be applied to other machine designs and processing methods. It is desirable to distribute the flow in a non-uniform manner in order to homogenize an initially non-homogeneous material and increase shear rates to cause dispersion of agglomerates within the material. Embodiments disclosed herein differ from conventional mixers by using integral flow channels with varying properties to achieve improved dispersion and distributive mixing as described below.

In one embodiment, a mixer includes an inlet surface, a plurality of integral flow channels, each having a inlet opening disposed on the inlet surface and an outlet opening, an outlet surface wherein each of the outlet openings are disposed thereon and a flow path of at least one flow channel of the plurality of integral flow channels comprises a non-linear flow path. Such a mixer improves the homogeneity of the material mix to be extruded/injected or otherwise processed.

In another embodiment, the flow path of the at least one flow channel of the plurality of integral flow channels has a different flow path length than a second different one of the plurality of integral flow channels. Such a mixer improves the distribution of larger lumps of varying density, color, states, or other properties of the material mix to be extruded/injected or processed. The process for distribution of the material mix is referred to herein as distributive mixing.

In yet another embodiment, the flow path of the at least one flow channel of the plurality of integral flow channels has a different cross section area than a second different one of the plurality of integral flow channels. Such a mixer provides improved dispersion of smaller additives such as microcrystalline cellulose, graphene, metal particles, and others through the controlled shearing of the melt (e.g., heated material mix) being processed. The process for dispersion of the material mix is referred to herein as dispersive mixing. In another embodiment, at least one flow channel of the plurality of integral flow channels intersects and is in fluid communication with at least one different one of the plurality of integral flow channels. Other embodiments incorporate both distributive and dispersive mixing elements within compact machine elements, such as breaker plates for use in extrusion machinery. In another embodiment, the flow path of the at least one flow channel of the plurality of integral flow channels has a cross section area which is either elliptical or polygonal shaped with rounded corners.

In other embodiments, the flow path of the at least one flow channel of the plurality of integral flow channels has a cross-section area which varies along a length of the flow path; the cross-section area of the flow channel decreases along a portion of the length of the flow path from the inlet opening to the outlet opening; the cross-section area of the flow channel increases along a portion of the length of the flow path from the inlet opening to the outlet opening; the cross-section area of the flow channel increases and decreases along different portions of the length of the flow path from the inlet opening to the outlet opening.

In other embodiments, the mixer includes a downstream mixer fluidly coupled to the inlet surface of the mixer; the mixer includes an upstream mixer fluidly coupled to the outlet surface of the mixer. In another embodiment, the at least one flow channel of the plurality of integral flow channels intersects and is in fluid communication with at least one different one of the plurality of integral flow channels. In still another embodiment, the plurality of integral flow channels follow a helical path. In one embodiment, the mixer includes a three-dimensional (3-D) metal printed structure.

Some disclosed embodiments include distributive and dispersive mixers compatible with standard breaker plate designs. Other embodiments provide angularly distributive mixing as well as dispersive mixing within a breaker plate Still another embodiment provides a distributive mixing stage in a disc portion compatible with a standard breaker plate design followed by a dispersive mixing stage and a second distributive mixing stage in a downstream conical section. These embodiments are readily used within extrusion and other polymer processing machinery (for example, injection molding, blow molding, resin transfer molding, and others) that transfer processed material from a plastication or feeding apparatus to a die, mold, or other forming apparatus. The mixers disclosed in these embodiments can be manufactured by three-dimensional (3-D) printing in stainless steel or other materials which can handle polymer processing temperatures and pressures.

A technique for mixing process includes providing material under pressure to a mixer; using a mixer which includes an inlet surface, a plurality of integral flow channels, each having a inlet opening disposed on the inlet surface and a outlet opening, an outlet surface wherein each of the outlet opening are disposed thereon and a flow path of at least one flow channel of the plurality of integral flow channels comprises a non-linear flow path. The technique further includes processing the material through the plurality of integral flow channels disposed such that the processed material is homogeneous.

In a further technique, the material is processed through flow channels such that the material is distributed in an outlet pattern different from an input pattern by varying a plurality of outlet locations relative to corresponding inlet locations. In another technique, the material is processed through flow channels such that the material is distributed in an outlet pattern different from an input pattern by varying a radial flow path direction, an axial flow path direction and an angular flow path direction for each of the flow channels of the plurality of integral flow channels.

In another technique, the material is processed through flow channels such that the material is dispersed in an outlet pattern different from an input pattern by varying a radial flow path direction, an axial flow path direction and an angular flow path direction for each of the flow channels of the plurality of integral flow channels. In yet another embodiment, two or materials are processed simultaneously.

The devices and techniques described herein can be applied to manufacturing processes require mixers (e.g., shut-off nozzles, runners, melt pumps, and other conveyance systems). In such systems, one or more mixers may be disposed between the pumping system and the forming system. The mixer will have an upstream location that mates with the pumping system as well as a downstream location that mates with the forming system. The mixer includes flow channels connecting the upstream location to the downstream location to mix the processed material.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

The foregoing and other aspects, embodiments, and features of the present teachings can be more fully understood from the following description in conjunction with the accompanying drawings.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1A is an isometric view of a distributive mixer according to embodiments herein;

FIG. 1B is an isometric view of the distributive mixer of FIG. 1A showing the flow channels connecting the input to the output;

FIG. 1C is a cross section of the distributive mixer of FIG. 1A with the front face oriented towards the upstream flow;

FIG. 1D is a cross-sectional view of the device of FIG. 1C, through line 1D of FIG. 1C, showing further details of the mixer;

FIG. 2A is an isometric view of a dispersive mixer according to embodiments herein;

FIG. 2B is an isometric view of the dispersive mixer of FIG. 2A showing the flow channels connecting the input to the output;

FIG. 2C is a cross section of the dispersive mixer of FIG. 2A with the front face oriented towards the upstream flow;

FIG. 2D is a cross-sectional view of the device of FIG. 2C, through line 2D of FIG. 2C, showing further details of the mixer;

FIG. 2E is a cross-sectional view of the device of FIG. 2C, through line 2E of FIG. 2C, showing further details of the mixer;

FIG. 3A is an isometric view of a distributive and dispersive mixer according to embodiments herein;

FIG. 3B is an isometric view of the distributive and dispersive mixer of FIG. 3A showing the flow channels connecting the input to the output;

FIG. 3C is a cross section of the distributive and dispersive mixer of FIG. 3A with the front face oriented towards the upstream flow;

FIG. 3D is a cross-sectional view of the device of FIG. 3C, through line 3D of FIG. 3C, showing further details of the mixer;

FIG. 4A is an isometric view of a distributive and dispersive mixer according to embodiments herein;

FIG. 4B is an isometric view of the distributive and dispersive mixer of FIG. 4A showing the flow channels connecting the input to the output;

FIG. 4C is a cross section of the distributive and dispersive mixer of FIG. 4A with the front face oriented towards the upstream flow;

FIG. 4D is a cross-sectional view of the device of FIG. 4C, through line 4D of FIG. 4C, showing further details of the mixer;

FIG. 5A is an isometric view of a distributive and dispersive multi-stage mixer according to embodiments herein;

FIG. 5B is an isometric view of the distributive mixer of FIG. 5A showing the flow channels;

FIG. 5C is a cross section of the distributive mixer of FIG. 5A with the front face oriented towards the upstream flow;

FIG. 5D is a cross-sectional view of the device of FIG. 5C, through line 5D of FIG. 5C, showing further details of the mixer;

FIG. 5E is a cross-sectional view of the device of FIG. 5C, through line 5E of FIG. 5C, showing further details of the mixer;

FIG. 6 is a flowchart of a process for designing mixers according to embodiments herein;

FIG. 7A is a discretization of the mixer design from the model of the distributive and dispersive multi-stage mixer of FIG. 5A used in a flow simulation;

FIG. 7B is representation of the material flow vectors through the flow channels of the model of FIG. 7A;

FIG. 8 is a graph of die pressures in dies connected to the mixers of FIG. 1A, FIG. 2A and FIG. 5A compared to a conventional mixer;

FIG. 9 is a graph of die melt temperatures in dies connected to the mixers of FIG. 1A, FIG. 2A and FIG. 5A compared to a conventional mixer; and

FIG. 10 is a schematic diagram of the multi-stage mixer of FIG. 5 disposed between an upstream supply providing two materials and a downstream die.

### DETAILED DESCRIPTION

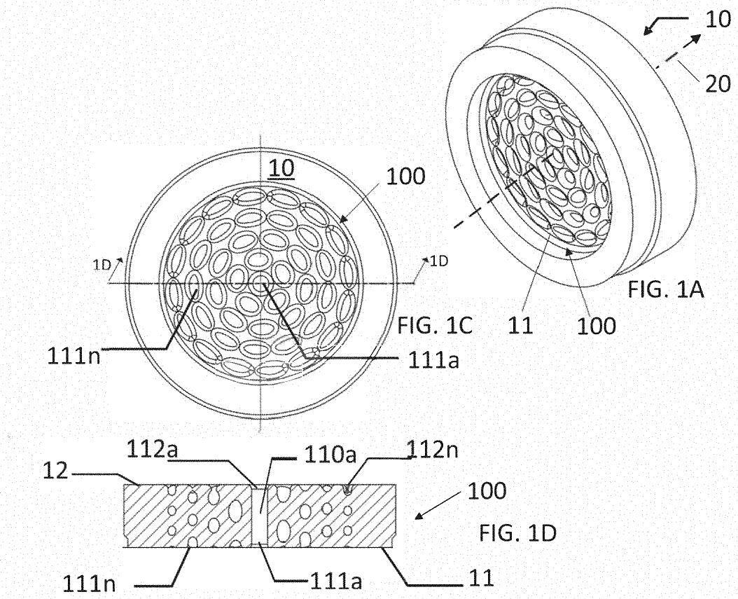

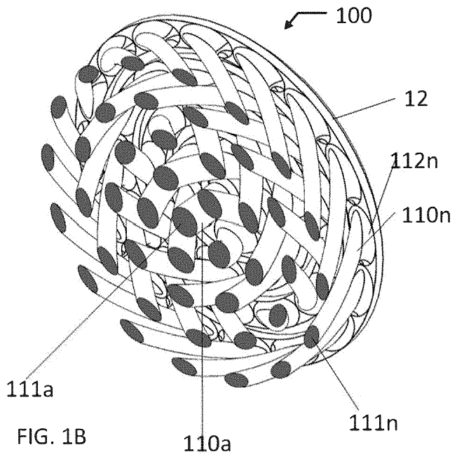

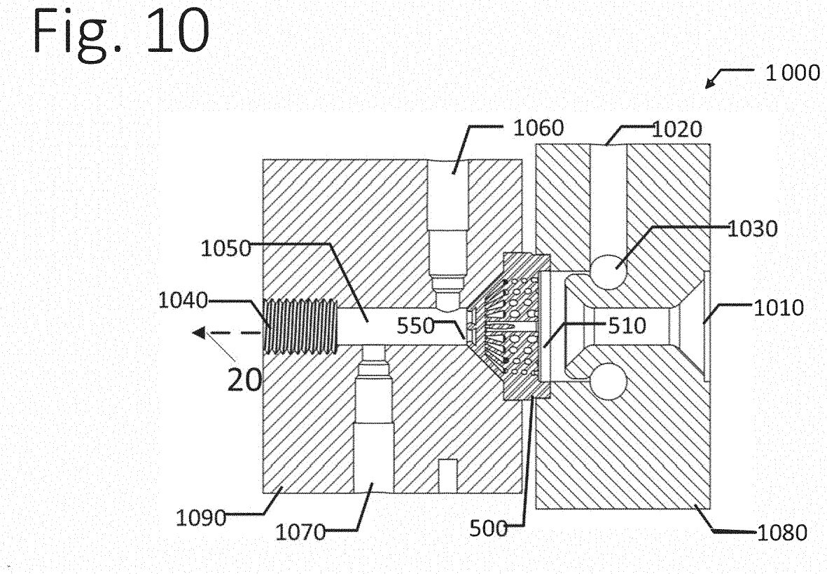

Now referring to FIGS. 1A, 1B and 1C, an extruder breaker plate 10 includes a mixer 100 a mixer disposed perpendicular to a flow axis 20 of an extruder 1000 (FIG. 10). The mixer 100 includes an inlet surface 11, a plurality of integral flow channels 110a-110n (each referred to as flow channel 110), each having an inlet opening 111 disposed on the inlet surface 11 and an outlet opening 112. The mixer 100 further includes an outlet surface 12 wherein each of the outlet openings 112 is disposed thereon. A flow path of at least one flow channel (e.g., flow channel 110n of the plurality of integral flow channels 110a-110n is a non-linear flow path. The flow path of flow channel 110n does not follow a straight line for the inlet opening 111n to the outlet opening 112n. In this embodiment the mixer 100 is referred to as a distributing mixer.

It is understood that the orientation of the distributive mixer could be reversed (inlet surface to outlet surface) depending on the application requirements. The mixer 100 is distributive in that the plurality of integral flow channels 110a-110n can vary in length, diameter, and angular disposition from one another. For example, channel 110a is a straight circular conduit of relatively large diameter providing a greater flow rate between the inlet opening 111a and outlet opening 112a. Another flow channel 110n provides a helical flow path in the clockwise direction with respect to the flow axis 20 and the outlet opening 112n is located approximately 120 degrees from the inlet opening 111n location. Flow channel 110n can have a smaller flow channel diameter and a greater flow channel length compared to flow channel 110a or other flow channels 110. As a result, flow channel 110n can shift incoming material in both time and space relative to, for example, material entering flow channel 110a.

In one embodiment, another flow channel 110 or set of flow channels 110 can sweep in the counter-clockwise direction and outlet the flow at a location approximately 240 degrees from the inlet location. These flow channels are longer with a smaller cross-section area than flow channels 110a or 110n to provide distributive mixing with regard to the radial and axial position of adjacent flow channels. Other flow channels can have a clockwise sweep with longer flow length and smaller cross sectional area than other flow channels. Still other flow channels can have a counter-clockwise sweep with a longer flow length and smaller cross-sectional area. In this embodiment, the flow channels are integral (i.e., the channels are fluidly closed except for the inlet opening 111 disposed on the inlet surface 11 and an outlet opening 112 disposed on the outlet surface 12).

In one embodiment, the length and diameter of each the plurality of integral flow channels 110a-110n are selected to provide the approximately same total amount of flow for each set of flow channels. However, it is understood that the number, length, and cross-sectional area of each flow channel may be varied using different analytical and computational techniques to obtain various objectives. For example, in one embodiment, the outer channels are designed to convey more flow than the inner channels, which may be accomplished by using shorter flow channels of larger cross-sectional area. It is also understood that inlet openings 111 or outlet openings 112 may appear elliptical in cross-section, but this is a result of simply sweeping a circular channel in a plane normal to the helical path of the flow channel. Such a design provides the greatest flow with the lowest chance for degradation of the processed material. In other embodiments the plurality of integral flow channels 110a-110n can have cross section shapes such as ellipses, triangles or squares or rectangles with rounded corners, and other shapes to accomplish various mixing objectives such as minimizing residence time, minimizing pressure drop, minimizing degradation, maximizing consistency, maximizing distributive mixing, and maximizing dispersive mixing.

It is understood that the swept flow of plurality of integral flow channels 110a-110n need not follow a helical path or be constant in cross-section. Other paths may include straight paths such as used in flow channel 110a having a linear flow path or an inclined straight path (not orthogonal to the view of FIG. 1A), or any multi-linear path, or any other curved or splined path, including combinations thereof.

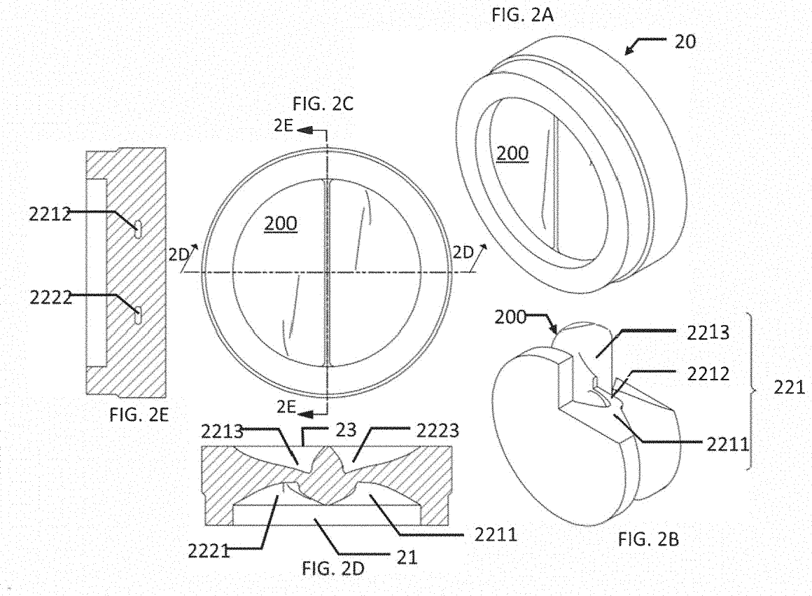

Now referring to FIGS. 2A-2E, a dispersive mixer 200 includes sets of flow channels 221 and 222. Flow channel 221 includes fluidly coupled sections 2211, 2212 and 2213. Flow channel 222 includes fluidly coupled sections 2221, 2222 and 2223. Flow channels 221 and 222 shown here, in one embodiment become smaller in sections and then become larger in sections. The dispersive mixer 200 further includes flow inlet 21 and flow outlet 23. Here, flow channels 221 are symmetric with respect to flow channel 222, but it is understood the number of flow channels and corresponding cross-sections can be varied.

In operation, converging-diverging flows through flow channels 221 and 222 provide elongated strain fields due to the smaller cross-sectional area of 2212 relative to the adjacent sections 2211 and 2213. The converging-diverging flows through flow channels 221 and 222 assist in dispersive flow. It is also understood that the radial location of the outlets of flow channels 221 and 222 can be varied relative to the corresponding inlets.

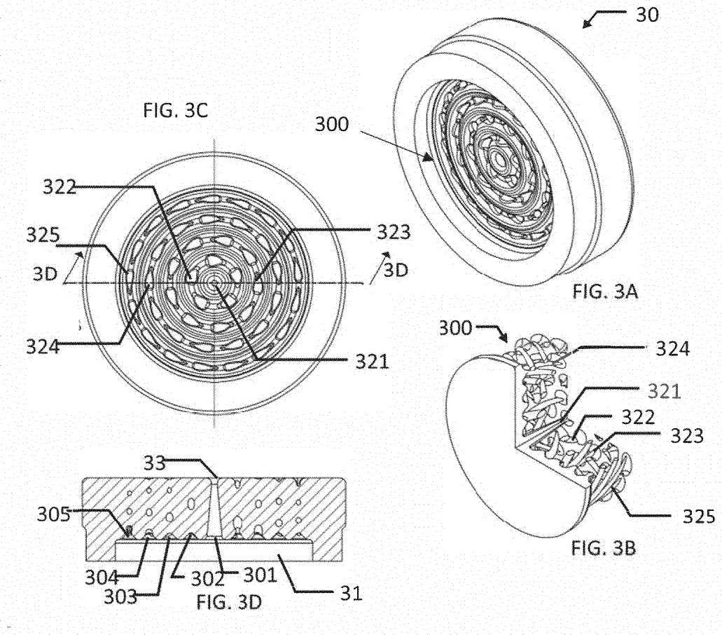

Now referring to FIGS. 3A-3D, a distributive and dispersive mixer 300 includes a set of flow channels 321, 322, 323, 324 and 325 (collectively referred to as flow channels 32) disposed between an inlet 31 and an outlet 33. In this embodiment, flow channels 32 vary in path rotation, flow channel length, and cross-section area. The mixer 300 also includes a set of concentric rings 301, 302, 303, 304, and 305 disposed at the inlet 31. Here, a cross-section shape of flow channels 32 was selected to be elliptical for illustrative purposes, but other designs could be readily used.

In operation the flow channels 32 provide distributive mixing due to variation in path rotation, flow channel length, and cross-section area similar to the mixer 100 of FIG. 1A and the flow channels 32 provide dispersive mixing due to cross-sectional area variation similar to the mixer 200 of FIG. 2A. Also in operation the set of concentric rings 301, 302, 303, 304, and 305 assists the fluid flow from inlet 31 into the flow channels 32 by minimizing the stagnation of flow between the inlets of the concentric sets of flow channels 321, 322, 323, 324, and 325. It is understood that similar concentric rings could be used at the outlet to minimize stagnation of flow at the outlets of the flow channels.

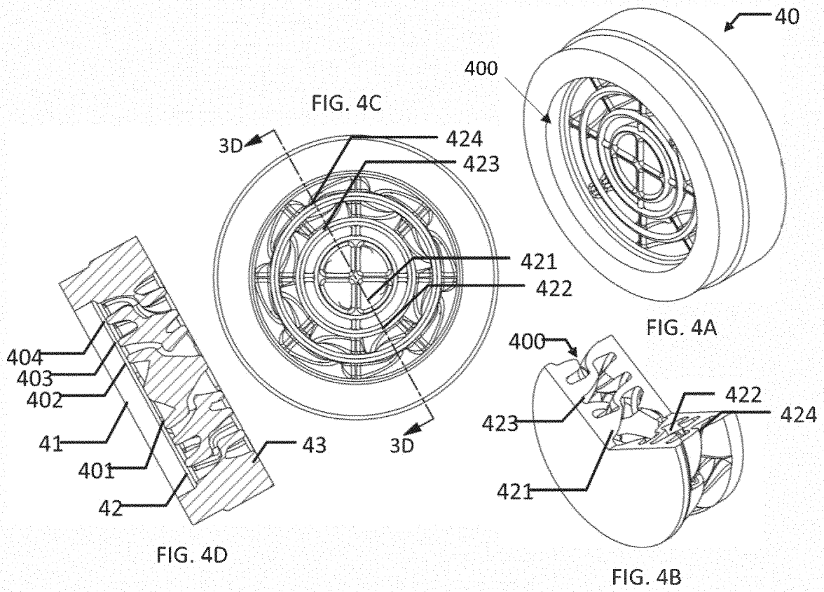

Now referring to FIGS. 4A-4D, a distributive and dispersive multi-stage mixer 400 includes a set of flow channels 421, 422, 323 and 424 (collectively referred to as flow channels 42) disposed between an inlet 41 and an outlet 43. In this embodiment, flow channels 42 include a lofted channel having a different inlet and outlet shape. Flow channel 421, for example, has an inlet section that is a triangular wedge shape that connects to the outlet of the adjacent flow channel 422 having an arc-shaped cross section. In between the inlet of flow channel 421 and outlet of flow channel 422, the cross-section area is reduced to provide a dispersive flow. Flow channels 423 and 424 are include eight sections that connect the inlet of flow channel 423 to the outlet of flow channel 423 as well as the inlet of flow channel 424 to the outlet of flow channel 423 with a reduced cross-sectional area to also provide a dispersive flow. In addition, each of the respective inlets and outlets include a set of concentric rings 401, 402, 403, and 404 to avoid flow stagnation.

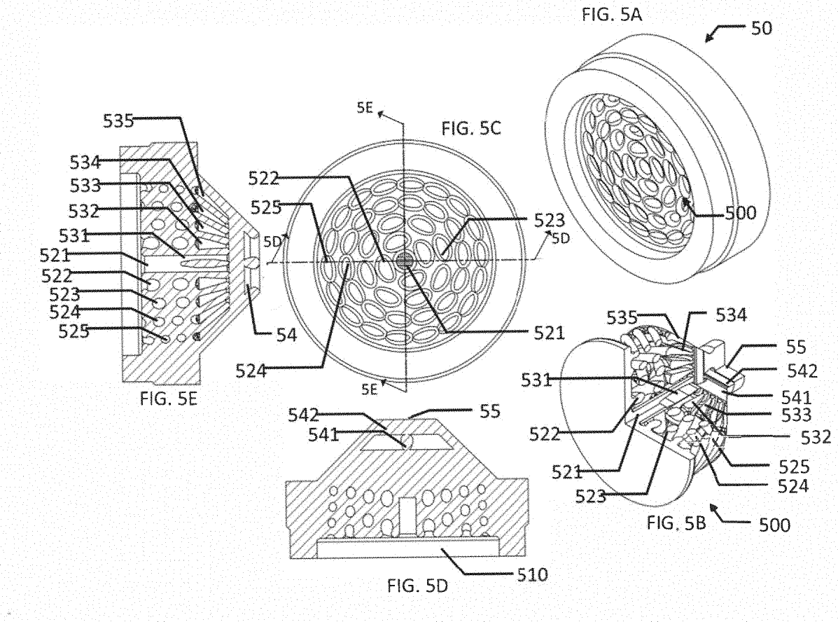

Now referring to FIGS. 5A-5E, a distributive and dispersive multi-stage mixer 500 includes a first set (first stage) of flow channels 521, 522, 523, 524, and 525 (similar to flow channels 110 in FIG. 1A and collectively referred to as distributive flow channels 52) that vary in path rotation, length, and cross-sectional area of the flow channels to provide distributive mixing. The distributive and dispersive multi-stage mixer 500 further includes a second set (second stage) of flow channels 531, 532, 533, 534, and 535 (similar to flow channels 221 in FIG. 2A and collectively referred to as dispersive flow channels 53) fluidly connected to respective ones of the first stage. The second stage flow channels vary in cross-sectional area to provide for dispersive flow. The distributive and dispersive multi-stage mixer 500 optionally includes a two-stage, conventional static mixer 54 having a set of crossing ribs 541 and 542. The multi-stage mixer 500 connects an inlet 51 to an outlet 55 via the distributive flow channels 52, the dispersive flow channels 53, and a static mixer section 54. In one embodiment, flow channels 521, 522, 523, 524, and 525 are connected to corresponding flow channels 531, 532, 533, 534, and 535.

In operation, flow channels 52 and 53 provide merged distributed and dispersive mixing. The merged distributed and dispersive flows are optionally fed through a two-stage, conventional static mixer 54 in which a set of crossing ribs 541 and 542 cuts and recombined prior to exiting the outlet 54. Here the static mixer 54 includes two levels of one crossing rib in each level, it is understood that the number of levels and number of crossing ribs in each level may be readily varied. It is further understood that the number, direction, size, shape, and change in shape of the flow channels may be altered to achieve various objectives. Generally, a greater number of channels and stages provides for greater distributive and dispersive mixing. Trade-offs between the number and relative size of the flow channels may be managed through the use of analytical and numerical methods as described below. It is understood that the order of the mixing stages provided herein with distributive, dispersive, and conventional static mixers can be varied and can also include multiple stages of the same type (e.g., two distributive mixing sections).

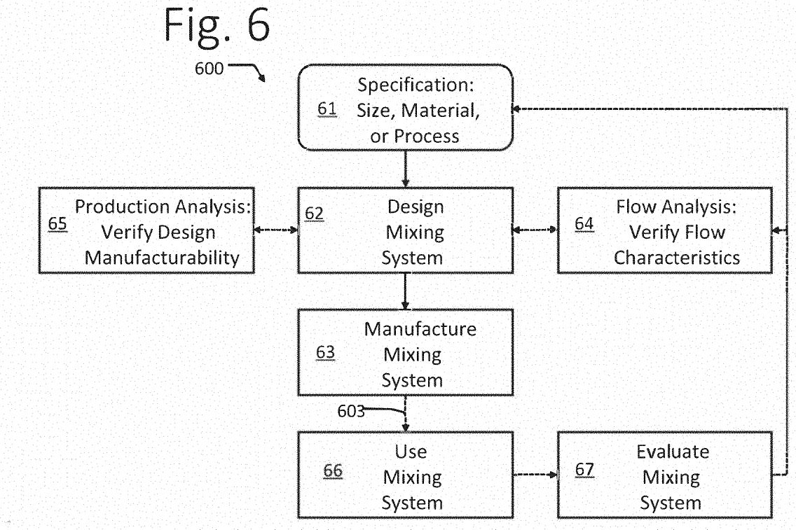

FIG. 6 is a flowchart 600 describing a process for designing mixers. A specification detailing size, material or process is generated in step 61. The specification typically includes the size of the mixer as well as a set of material properties and process requirements pertaining to the desired conditions of the fluid flow at the inlet and outlet. In the absence of specific information, it is understood that one could use default information such as a Newtonian fluid viscosity and operating flow rate. This information 601 is stored and conveyed to a design system in step 62. In one embodiment, the design system is implemented as a three-dimensional computer aided design representation. The design mixer can be fully automated, for example through a application programming interface (API) that derives the mixer and internal flow channel geometry according to defined design methodology such as described above for the first to fifth embodiments. The candidate geometry may be analyzed with a production analysis in step 65 to verify the manufacturability of the design. In one embodiment, the candidate geometry is assessed for a variety of rules to check the overall size against minimum and maximum, the minimum flow channel dimensions, the minimum wall thickness dimensions, and others. Such manufacturability rules may also be incorporated directly within the design methodology in step 62 such that a separate manufacturability analysis in step 65 is not necessary. Concurrently, the candidate flow channel geometry may be analyzed with a flow analysis in step 64 to ensure suitable flow characteristics with respect to distributive and dispersive mixing. Such a flow analysis is described with respect to the seventh embodiment, but suitable analysis can be incorporated into the design methodology 62 so that a separate flow analysis 64 is not necessary.

Once a suitable design is created, it is transmitted to the manufacturing system in step 63. It is understood that many different manufacturing techniques can be used including additive, subtractive, and net-shape manufacturing techniques. In one embodiment, three-dimensional printing of stainless steel has been found useful with respect to minimum cost and robust performance. In this process, small quantities of adhesive are applied to a layer of fine stainless steel powder, one layer at a time, to define the fused cross section of each layer. The adhered stainless steel object then enters an infusion process to replaces the adhesive with bronze, creating a strong metal device. The device is then polished to achieve improve the surface finish, typically with sand blasting of the inner and outer surfaces. It has been found that such a three-dimensional printing process can provide the described embodiments at a lower cost than traditional components. Another method for manufacture of the mixer is investment casting from a pattern that is made of three-dimensionally printed wax. Such a technique can provide improved surface quality. Yet another technique is direct metal laser sintering or selective laser melting suitable for steel and aluminum alloys.

Once the suitable design is embodied as a mixer, it may be used in a process in step 66. The performance data for the mixer may be collected through the use of process instrumentation such as temperature, pressure, and flow rate sensors located upstream and downstream of the mixer. This performance data can then be used in an evaluation in step 67 of the mixer to provide feedback for example to change the initial specifications or otherwise provide feedback for improving the flow analysis in step 64, design system in step 62, manufacturability analysis in step 65, or manufacturing system in step 63.

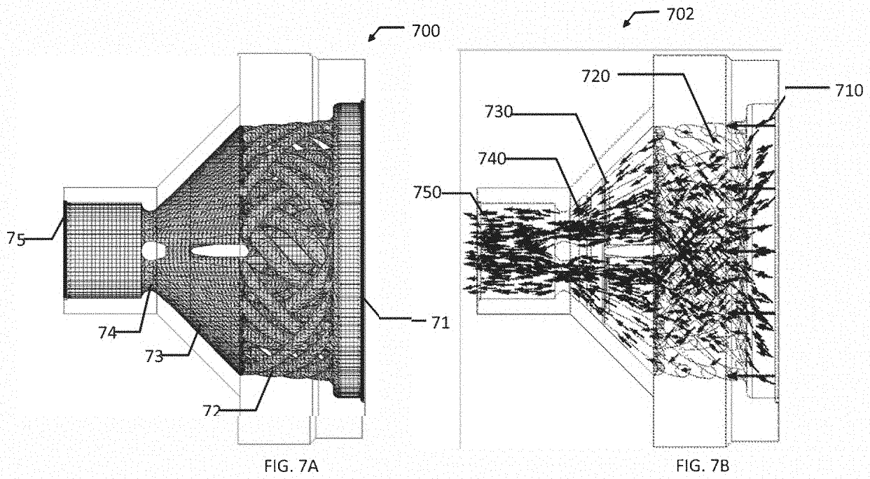

FIGS. 7A and 7B illustrate discretization of the mixer 500 and the flow 700 of the processed material therein. Here, the term “processed material” generally means the material flowing through the mixing device. The discretization (e.g., simulation) includes a three dimensional finite element model of the inlet 71, distributive flow channels 72, dispersive flow channels 73, static mixing section 74, and outlet 75. An inlet boundary condition 710 is applied to the inlet and typically includes inlet melt temperature as well as inlet melt pressure or flow rate. In one embodiment, 710 represents the specification of a flow velocity at the inlet, though the arrows are not provided to scale with the actual flow rate. A pressure boundary condition is provided at the outlet 75, though the specification of the inlet and outlet boundary conditions may be readily altered in accordance with the application of the mixer. An iterative numerical simulation is then applied to predict the flows 720, 730, 740, and 750 through the respective flow channels in the inlet 71, distributive flow channels 72, dispersive flow channels 73, static mixing section 74, and outlet 75. In this simulation, a low-density polyethylene (LDPE) was simulated as a power law fluid. The fluid may be readily modeled as not only non-Newtonian, but also non-isothermal and compressible.

The embodiments shown in FIG. 5A and the simulation in FIG. 7B illustrate the use of multiple flow channels that intersect and are in fluid communication, allowing the division and recombination of the material being processed. Such divisions can increase the elongational flow of the material being processed, increasing the distributive and dispersive mixing to increase the consistency and quality of the manufactured product. Such division and recombination of the flow channels can be incorporated in the other embodiments (e.g., mixers 100, 200 and 400 in FIGS. 1A, 3A, and 4A respectively) by alternating the angular or radial direction of the flow channels so that the flow channels 110 intersect.

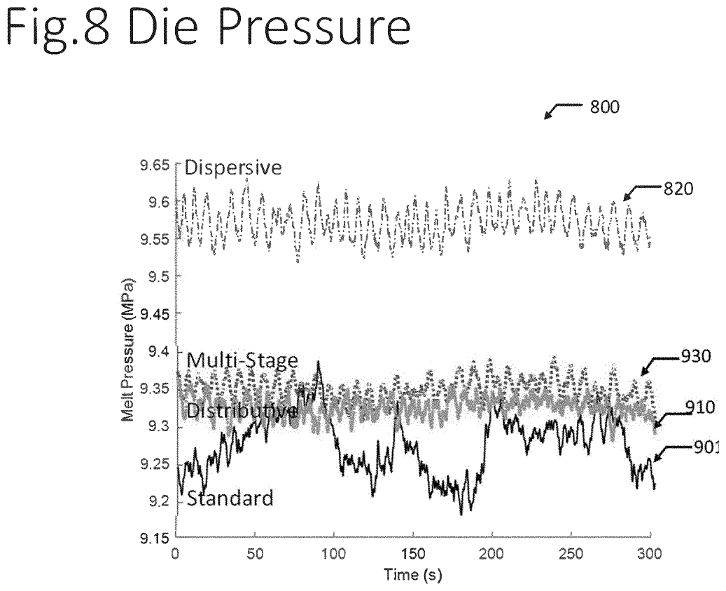

FIG. 8 is a graph 800 of: die pressure 801 in a die connected to a standard mixer (e.g., conventional breaker plate); die pressure 810 in a die connected to the distributive mixer 100 of the embodiment of FIG. 1A; die pressure 820 in a die connected to the dispersive mixer 200 of the embodiment of FIG. 2A; and die pressure 830 in a die connected to the distributive and dispersive mixer 500 (also referred to as multi-stage mixer 500) of the embodiment of FIG. 5A.

In one experiment, a high impact polystyrene (HIPS) was processed in an extruder with a screw diameter of 1.5 inches (38 mm). The die and adjacent barrel zone were set to 200° C. with a screw speed set to 40 rotations per minute (RPM). The various breaker plates were placed between the barrel and the die, and the extruder operated for 30 minutes at steady state conditions with a conventional general-purpose screw. It is noted that the standard breaker plate design has the lowest mean melt pressure in the die but the largest variance; the standard breaker plate design has significant excursions in which variations in the melt are transmitted to the die resulting in fluctuations in melt pressure. The distributive mixer 100 requires a slightly higher melt pressure to operate but provides a significantly reduced variation in the melt pressure. The dispersive mixer 200 requires the highest operating melt pressure but also reduces the variance in the melt pressure while providing improved dispersion. The multi-stage mixer 500 requires a slightly higher level of melt pressure but also reduced melt pressure variance compared to the standard design.

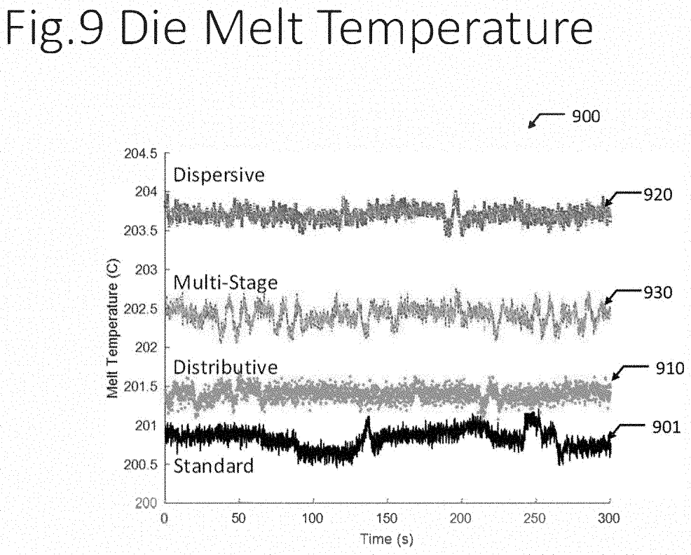

FIG. 9 is a graph 900 of: melt temperature 901 in a die connected to a standard mixer (e.g., conventional breaker plate); melt temperature 910 in the die connected to the distributive mixer 100 of the embodiment of FIG. 1A; melt temperature 920 in the die connected to the dispersive mixer 200 of the embodiment of FIG. 2A; and melt temperature 930 in the die connected to the distributive and dispersive mixer 500 (also referred to as multi-stage mixer 500) of the embodiment of FIG. 5A.

An intrusive melt thermocouple probe was used to obtain the data, with the thermocouple probe located at the center-line of the melt stream flowing through a 0.5 inch (12.7 mm) bore in the die. It is observed that the standard breaker plate has the lowest operating melt temperature but also the highest variation with significant excursions. The distributive design 1, dispersive design 2, and multi-stage design 5 all have slightly increased melt temperatures but lower variations in melt temperature.

A laser micrometer was implemented to measure the diameter of the extrudate produced with from the die with a circular orifice having a 3 mm diameter. The laser micrometer was configured to provide the diametral dimensions in the horizontal and vertical directions relative to the die. The area of the extrudate was calculated as the product of the number pi divided by four, the horizontal diametral measurement, and the vertical diametral measurement. For all the tested designs, the mean extrudate areas were very similar corresponding to a mean diameter of approximately 3.3 mm.

The standard deviations of the melt pressure, temperature, and extrudate area were computed and are provided in TABLE 1. It is noted that all of the provided embodiments provide improved consistency compared to the standard breaker plate design. The unexpected result of improved consistency is significant given that the actual embodiments used for validation were provided at a cost no greater than the standard breaker plate design and required no changes to the extrusion system.

TABLE 1
STANDARD DEVIATIONS OF VARIOUS EMBODIMENTS

| | | | | Multi- |
|---|---|---|---|---|
| Design | Standard | Distributive | Dispersive | Stage |
| Melt Pressure (MPa) | 0.0376 | 0.0119 | 0.0159 | 0.0227 |
| Melt Temperature (C.) | 0.1245 | 0.0832 | 0.0827 | 0.1208 |
| Extrudate Area (mm²) | 0.2081 | 0.1399 | 0.1694 | 0.1271 |

While molten low-density polyethylene (LDPE) and high-impact polystyrene (HIPS) were used as example fluids herein for an extrusion process, it is understood that embodiments shown in FIGS. 1A-5E may be readily applied to other fluids including not only other polymers but also other liquids and gases and particle systems. It is noted that there are many direct applications beyond extrusion of polymeric materials and their composites. The described embodiments are also directly applicable to other polymer processing methods such as injection molding, blow molding, thermoforming, rotomolding, and other similar systems in which a melt stream is generated from one or more feedstocks. The disclosed mixers are useful beyond conventional polymer processing and are applicable to any application requiring improved distributed and dispersive mixing such as paint and food processing, pharmaceutical compounding, drug delivery via intravenous fluids or nebulizer gases, and others. It is understood that a gas is a type of fluid, and that the described embodiments can be applied to various types of gases, liquids, and solids to be mixed amongst materials of various phases.

It is understood that the described embodiments provide advantageous processing of single material systems. Indeed, the results of FIGS. 8-9 and TABLE 1 are for a single feedstock material (HIPS). The reason is that the single material being processed may vary in temperature, pressure, and flow rate as a result of its residence time and processing history within the upstream processing elements. As such, the single feedstock material may vary in composition or state at the inlet of the mixer and so benefit from distributive and/or dispersive mixing.

Furthermore, while the provided embodiments suggest a single material entering at a single inlet location, it is understood that multiple different materials may be introduced to the inlet through one or more feed ports that vary in angular, radial, or axial positions relative to the center of the inlet to the mixer.

Now referring to FIG. 10, a multi-stage mixer 500 is incorporated within a injection molding apparatus 1000 and is disposed downstream of two coaxially channels 1010 and 1020 which receive materials provided through machine component 1080 (e.g., a barrel, nozzle, die, etc). In this embodiment, a first material is provided through channel 1010 (inlet). A second material is provided through channel 102 (a side inlet) that feeds into an annulus 1030 to provide the second material as an outer layer to the first material. The two materials are then fed to the inlet 510 of the mixer, through the mixer 500, and out of the outlet 550 of the mixer to the bore 1050 of a barrel, nozzle, die or other machine component 1090. Other optional components include a bore 1060 for the pressure transducer as well as a bore 1070 of the temperature transducer (which, for example were used to provide the data for FIGS. 7-8). Threaded outlet 1040 is used to receive adaptors for further processing of the distributively and dispersively mixed materials.

The section headings used herein are for organizational purposes only and are not to be construed as limiting the subject matter described in any way. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the inventive scope of the present disclosure.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Further, one or more of the method acts may be omitted in some embodiment, while in other embodiments additional acts may be added. In some implementations, one or more of the acts of a method may be replaced with one or more other acts.

All definitions, as defined and used herein, should be understood to control over dictionary definitions, definitions in documents incorporated by reference, and/or ordinary meanings of the defined terms. ‘The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A mixer comprising;
an inlet surface;
a plurality of integral flow channels, each having an inlet opening disposed on the inlet surface and an outlet opening;
an outlet surface wherein each of the outlet openings are disposed thereon; and
wherein a flow path of at least one flow channel of the plurality of integral flow channels comprises a non-linear flow path.

2. The mixer of claim 1 wherein the flow path of the at least one flow channel of the plurality of integral flow channels has a different flow path length than a second different one of the plurality of integral flow channels.

3. The mixer of claim 1 wherein the flow path of the at least one flow channel of the plurality of integral flow channels has a different cross section area than a second different one of the plurality of integral flow channels.

4. The mixer of claim 1 wherein the flow path of the at least one flow channel of the plurality of integral flow channels has a cross section area which is one of:
elliptical; and
polygonal shaped with rounded corners.

5. The mixer of claim 1 wherein the flow path of the at least one flow channel of the plurality of integral flow channels has a cross-section area which varies along a length of the flow path.

6. The mixer of claim 5, wherein the cross-section area of the flow channel decreases along a portion of the length of the flow path from the inlet opening to the outlet opening.

7. The mixer of claim 5, wherein the cross-section area of the flow channel increases along a portion of the length of the flow path from the inlet opening to the outlet opening.

8. The mixer of claim 5, wherein the cross-section area of the flow channel increases and decreases along different portions of the length of the flow path from the inlet opening to the outlet opening.

9. The mixer of claim 1 further comprising a downstream mixer fluidly coupled to the inlet surface of the mixer.

10. The mixer of claim 1 further comprising an upstream mixer fluidly coupled to the outlet surface of the mixer.

11. The mixer of claim 1, wherein the mixer comprises a three-dimensional (3-D) metal printed structure.

12. The mixer of claim 1, wherein the at least one flow channel of the plurality of integral flow channels intersects and is in fluid communication with at least one different one of the plurality of integral flow channels.

13. The mixer of claim 1, wherein the plurality of integral flow channels follow a helical path.

14. A mixing process comprising:
providing material under pressure to a mixer;
wherein the mixer comprises:
an inlet surface;
a plurality of integral flow channels, each having an inlet opening disposed on the inlet surface and an outlet opening;
an outlet surface wherein each of the outlet opening are disposed thereon; and
wherein a flow path of at least one flow channel of the plurality of integral flow channels comprises a non-linear flow path; and
processing the material through the plurality of integral flow channels disposed such that the processed material is homogeneous.

15. The mixing process of claim 14, wherein the material is processed through flow channels such that the material is distributed in an outlet pattern different from an input pattern by varying a plurality of outlet locations relative to corresponding inlet locations.

16. The mixing process of claim 14, wherein the material is processed through flow channels such that the material is distributed in an outlet pattern different from an input pattern by varying one of:
a radial flow path direction;
an axial flow path direction; and
an angular flow path direction; and
of each of the flow channels of the plurality of integral flow channels.

17. The mixing process of claim 14, wherein the material is processed through flow channels such that the material is dispersed in an outlet pattern different from an input pattern by varying one of:
a radial flow path direction;
an axial flow path direction; and
an angular flow path direction; and
of each of the flow channels of the plurality of integral flow channels.

18. The mixing process of claim 14, in which two or materials are processed simultaneously.
